(19) United States
(12) Patent Application Publication
(10) Pub. No.: US 2015/0266702 A1
(43) Pub. Date: Sep. 24, 2015

(54) ELEVATOR

(71) Applicant: KONE Corporation, Helsinki (FI)

(72) Inventors: Santeri SUORANTA, Espoo (FI); Johannes DE JONG, Jarvenpaa (FI)

(73) Assignee: KONE CORPORATION, Helsinki (FI)

(21) Appl. No.: 14/622,301

(22) Filed: Feb. 13, 2015

(30) Foreign Application Priority Data
Mar. 18, 2014 (EP) 14160513.9

(51) Int. Cl. B66B 11/00; B66B 15/04; B66B 9/00

(52) U.S. Cl. CPC B66B 11/008; B66B 9/00; B66B 15/04

(57) ABSTRACT

An elevator includes a hoistway, and an elevator car and a counterweight vertically movable in the hoistway. The elevator includes at least one first stationary mounted rope wheel positioned in proximity of the upper end of the hoistway, and at least one second stationary mounted rope wheel positioned in proximity of the upper end of the hoistway, the at least one first stationary mounted rope wheel and the at least one second stationary mounted rope wheel being horizontally spaced apart and rotating on different vertical planes of rotation, and a roping, including at least one belt-shaped rope interconnecting the elevator car and counterweight and including a rope portion extending between the car and counterweight, which passes around the at least one first stationary mounted rope wheel and around the at least one second stationary mounted rope wheel, and at least one intermediate stationary mounted rope wheel, positioned at a distance apart from the at least one first rope wheel and the at least one second rope wheel to rotate on a plane of rotation that intersects the plane of rotation of the at least one first rope wheel and the plane of rotation of the at least one second rope wheel, and arranged to guide the portion of the rope extending between the at least one first rope wheel and the at least one second rope wheel to pass from the plane of rotation of the at least one first wheel to the plane of rotation of the at least one second wheel along the plane of rotation of the at least one intermediate stationary mounted rope wheel.

### FIELD OF THE INVENTION

The invention relates to an elevator. The elevator is particularly meant for transporting passengers and/or goods.

### BACKGROUND OF THE INVENTION

An elevator typically comprises a hoistway, an elevator car and a counterweight both vertically movable in the hoistway, and a drive machine which drives the elevator car under control of an elevator control system. The drive machine typically comprises a motor and a driven rope wheel engaging an elevator roping connected to the car. Thus, driving force can be transmitted from the motor to the car via the driven rope wheel and the roping. The roping elevator car and counterweight passes around one or more rope wheels mounted stationary in proximity of the upper end of the hoistway, i.e. inside the end space of the hoistway or inside a machine room of the elevator above or adjacent the hoistway. Typically these one or more rope wheels include also the driven rope wheel mentioned above.

Proper guidance of the rope between consecutive rope wheels has meant that the rope does not undergo excessive twist while passing from one wheel to another, but also that it departs from and arrives at each rope wheel at least substantially tangentially. This has set limitations on how the rope wheels can be positioned relative to each other. A drawback of the known elevators has been that freedom of design has been limited. Problems of limited freedom of design have risen particularly in cases where the elevator would need to have stationary rope wheels mounted at the proximity of the upper end of the hoistway without placing them in coplanar configuration i.e. so that they don't have the same plane of rotation. These kinds of limitations have been especially difficult to overcome with elevators wherein the car and counterweight are suspended via rope wheels mounted on the car and counterweight, i.e. elevators with suspension ratio of 2:1 or higher. The positioning of the stationary rope wheels in proximity of the upper end of the hoistway has not been free enough. For this reason, it has been difficult to design an elevator wherein the car and counterweight are suspended via rope wheels mounted centrally on top of the car and counterweight, for instance.

### BRIEF DESCRIPTION OF THE INVENTION

The object of the invention is, inter alia, to solve previously described drawbacks of known solutions and problems discussed later in the description of the invention. The object of the invention is to introduce a new elevator which is improved in terms of its rope guidance and rope wheel positioning. In particular, an object is to achieve a suspension where stationary rope wheels of the elevator can be placed in an uncoplanar configuration without causing strong twist or improper route for the ropes. Embodiments are presented, inter alia, where the car and counterweight are suspended from suspension points located at least substantially centrally on top of these car and counterweight.

It is brought forward a new elevator, which, comprises a hoistway and an elevator car and a counterweight, which are vertically movable in the hoistway. The elevator further comprises at least one first stationary mounted rope wheel positioned in proximity of the upper end of the hoistway, and at least one second stationary mounted rope wheel positioned also in proximity of the upper end of the hoistway, wherein the at least one first stationary mounted rope wheel and the at least one second stationary mounted rope wheel are horizontally spaced apart and rotate on different vertical planes of rotation. Thus their planes of rotation are not coplanar. The elevator further comprises a roping, comprising at least one belt-shaped rope interconnecting the elevator car and counterweight and comprising a rope portion extending between the car and counterweight, which rope passes around the at least one first stationary mounted rope wheel and around the at least one second stationary mounted rope wheel. The elevator further comprises at least one intermediate stationary mounted rope wheel, positioned at a distance apart from the at least one first rope wheel and the at least one second rope wheel to rotate on a plane of rotation that intersects both the plane of rotation of the at least one first rope wheel and the plane of rotation of the at least one second rope wheel, and arranged to guide the portion of the rope extending between the at least one first rope wheel and the at least one second rope wheel to pass from the plane of rotation of the at least one first wheel to the of rotation of the at least one second wheel along the plane of rotation of the at least one intermediate stationary mounted rope wheel. In this way, guidance of the rope from the plane of rotation of the first rope wheel to the plane of rotation of the second rope wheel is facilitated. Thus, one or more of the above given objects can be achieved. Particularly, in this way a new elevator can be provided, which is improved in terms of its rope guidance and rope wheel positioning. Furthermore, thus a suspension can be achieved where stationary rope wheels of the elevator can be placed in an uncoplanar configuration without causing strong twist or improper route for the ropes.

In a preferred embodiment, the rope portion extending between the first and second rope wheels is arranged to pass, in particular departing tangentially therefrom, from a rim of the first rope wheel to a rim of the at least one intermediate rope wheel, in particular arriving tangentially thereto, and to pass along a rim of said at least one intermediate rope wheel away from the plane of rotation of the first rope wheel, and to pass along a rim of said at least one intermediate rope wheel to the plane of rotation of the second rope wheel, and to pass from the rim of the intermediate rope wheel, in particular departing tangentially therefrom, to the rim of the second wheel, in particular arriving tangentially to it. In this way, proper guidance of the rope, without considerable twist thereof, from the plane of rotation of the first rope wheel to the plane of rotation of the second rope wheel is facilitated.

In a preferred embodiment, the at least one first stationary mounted rope wheel rotates on a first vertical plane of rotation, which is at a first nonzero angle relative to the plane of rotation of the at least one intermediate rope wheel, and the at least one second stationary mounted rope wheel rotates on a second vertical plane of rotation, which is at a second nonzero angle relative to the plane of rotation of the at least one intermediate rope wheel. In this way, the rope is guided from one plane to another by guiding it along the plane of rotation of the at least one intermediate rope wheel by stepwise changing the direction of the rope. Said first angle and second angle can be either different or the same.

In a preferred embodiment, the rope portion extending between the first and second rope wheels is arranged to pass from a rim of the at least one first rope wheel to a rim of the at least one intermediate rope wheel twisting between the rim of the at least one first rope wheel and the rim of the at least one intermediate rope wheel around its longitudinal axis an amount of said first nonzero angle, and to pass without twisting around its longitudinal axis along a rim of the at least one intermediate rope wheel away from the plane of rotation of the first rope wheel, and to pass without twisting around its longitudinal axis along a rim of the at least one intermediate rope wheel to the plane of rotation of the second rope wheel, and to pass from the rim of the at least one intermediate rope wheel to a rim of the at least one second rope wheel twisting between the rim of the intermediate rope wheel and the rim of the second rope wheel around its longitudinal axis an amount of said second nonzero angle. In this way, proper guidance of the rope, with minimal twist thereof, from the plane of rotation of the first rope wheel to the plane of rotation of the second rope wheel is facilitated.

In a preferred embodiment, said intermediate rope wheel is positioned at a substantial vertical distance lower than the first and second rope wheels. Thus, the rope can be routed in compact fashion. Each intermediate rope wheel is preferably positioned in the hoistway, whereby the distance can be easily adjusted suitable without harming space efficiency of the elevator. In particular, each intermediate rope wheel is preferably positioned beside the paths of the car and counterweight.

In a preferred embodiment, said rope portion extending between the car and counterweight passes around and over the at least one first rope wheel, around and under the at least one intermediate rope wheel, and around and over the at least one second rope wheel in this order. These rope wheels are thereby positioned in this order along the length of the rope portion to act on parts of the rope portion which are consecutive in this order.

In a preferred embodiment, said roping is a suspension roping for suspending the elevator car and the counterweight, i.e. each of said at least one rope is a suspension rope.

In a preferred embodiment, on one side of the stationary mounted first, second and intermediate rope wheels, the roping (by its ropes) suspends the elevator car and on the other side of these stationary mounted rope wheels, the roping (by its ropes) suspends the counterweight.

In a preferred embodiment, each of the at least one intermediate wheel is a non-driven rope wheel. Thus, it can be positioned in tight space, for example in the hoistway beside the paths of the car and counterweight.

In a preferred embodiment, said distance is at least 4 meters, preferably between 4 to 10 meters.

In a preferred embodiment, either the at least one first rope wheel or the at least one second rope wheel comprises a rope wheel driven by a motor under control of an automatic elevator control system.

In a preferred embodiment, said at least one first rope wheel includes only one rope wheel or several coplanar rope wheels (i.e. having same plane of rotation), and said at least one second first rope wheel includes only rope wheel or several coplanar rope wheels (i.e. having same plane of rotation), and said at least one intermediate rope wheel includes only rope wheel or several coplanar rope wheels (i.e. having same plane of rotation).

In a preferred embodiment, the roping, in particular the ropes thereof, suspends the car via at least one rope wheel mounted on the car and the counterweight via at least one rope wheel mounted on the counterweight.

In a preferred embodiment, the roping, in particular the ropes thereof, suspends the car via at least one rope wheel mounted on the car, which at least one rope wheel is mounted at least substantially centrally on top of the car, for example on the car roof. Thus, the car can be suspended centrally in a simply way.

In a preferred embodiment, the roping, in particular the ropes thereof, suspends the counterweight via at least one rope wheel mounted on the counterweight, which at least one rope wheel is mounted at least substantially centrally on top of the counterweight. Thus, the counterweight can be suspended centrally in a simply way.

In a preferred embodiment, the counterweight is arranged to travel vertically on first of the four lateral sides of path of the car, and the at least one intermediate rope wheel is positioned on a second of the four lateral sides of path of the car, said first and second lateral sides being neighboring lateral sides of the four lateral sides of path of the car. Thereby, it can be left optional to position the doorway to the interior of the car on either of two neighboring lateral sides of the four lateral sides of path of the car. The layout is thus simple and it leaves freedom of choice for the designer.

In a preferred embodiment, the elevator car further comprises a doorway allowing passage of a person to the interior of the car, which doorway is positioned either on a lateral side of the car which is opposite the lateral side on which the counterweight travels or on a lateral side of the car, which is opposite the lateral side on which the at least one intermediate rope wheel is positioned.

In a preferred embodiment, the plane of rotation of the at least one second rope wheel is at least substantially aligned with the width direction of the counterweight. Thus, the rope can be turned within the vertical projection of the counterweight even with solutions requiring a large turning radius, such as ropes containing load bearing members of fiber reinforced composite.

In a preferred embodiment, the rope wheel mounted on the counterweight rotates on the plane of rotation of the at least one second rope wheel, which plane of rotation is at least substantially aligned with the width direction w of the counterweight.

In a preferred embodiment, the rope wheel mounted on the car rotates on the plane of rotation of the at least one first rope wheel.

In a preferred embodiment, the at least one first rope wheel and the at least one second rope wheel are positioned at the same side of the plane of rotation of the intermediate rope wheel, one of them turning rope on a rim thereof to the plane of rotation of the at least one intermediate rope wheel during movement of rope in a certain direction and the other of them turning the rope on a rim thereof back away from the plane of rotation of the at least one intermediate rope wheel during movement of rope in said certain direction, and vice versa.

In a preferred embodiment, the running direction of rope is changed stepwise between the first and second rope wheels such that the vertical projection of the rope has substantially the shape of a letter U.

In a preferred embodiment, the running direction of the rope, when viewed from above turns at least 120 degrees, but preferably at most 180 degrees between the first and second wheels.

In a preferred embodiment, each of said at least one rope comprises one or more continuous load bearing members extending in longitudinal direction of the rope throughout the length of the rope, which load bearing member(s) is/are made of composite material comprising reinforcing fibers embedded in polymer matrix, the reinforcing fibers preferably being carbon fibers. In combination of composite material of the load bearing member, especially when the fibers are carbon fibers, the amount of twist and improper rope guidance is important to be minimized. Thereby, the function provided by the intermediate rope wheel(s) is specifically important in this context. The reinforcing fibers are most preferably carbon fibers, which are most advantageous in terms of load-bearing ability as well as weight. Particularly, thereby the rope has good longitudinal stiffness and low weight, which are among preferred properties for an elevator. Preferably, the load bearing member(s) is/are parallel with the longitudinal direction of the rope. In this way, it/they provide excellent longitudinal stiffness for the rope. The reinforcing fibers are also preferably parallel with the longitudinal direction of the rope, which facilitates further the longitudinal stiffness of the rope. Preferably, the rope is such that reinforcing fibers are distributed in the matrix substantially evenly. Also preferably, all the individual reinforcing fibers of the load bearing member are bound to each other by the matrix.

The elevator as describe anywhere above is preferably, but not necessarily, installed inside a building. The car is preferably arranged to move vertically and serve two or more landings. The car is preferably arranged to respond to calls from landing(s) and/or destination commands from inside the car so as to serve persons on the landing(s) and/or inside the elevator car. Preferably, the car has an interior space suitable for receiving a passenger or passengers.

### BRIEF DESCRIPTION OF THE DRAWINGS

In the following, the present invention will be described in more detail by way of example and with reference to the attached drawings, in which

FIG. 1 illustrates schematically a flattened side view of an elevator according to an embodiment of the invention.

FIG. 2 illustrates a first preferred configuration of stationary mounted rope wheels for the elevator of FIG. 1.

FIG. 3 illustrates a second preferred configuration of stationary mounted rope wheels for the elevator of FIG. 1.

FIG. 4 illustrates further preferred details for the elevator of FIGS. 1 and 2.

FIG. 5 illustrates further preferred details for the elevator of FIGS. 1 and 3.

FIG. 6 illustrates a preferred structure for the rope(s).

FIG. 7 illustrates a preferred internal structure for the load bearing member(s) of the rope(s).

### DETAILED DESCRIPTION

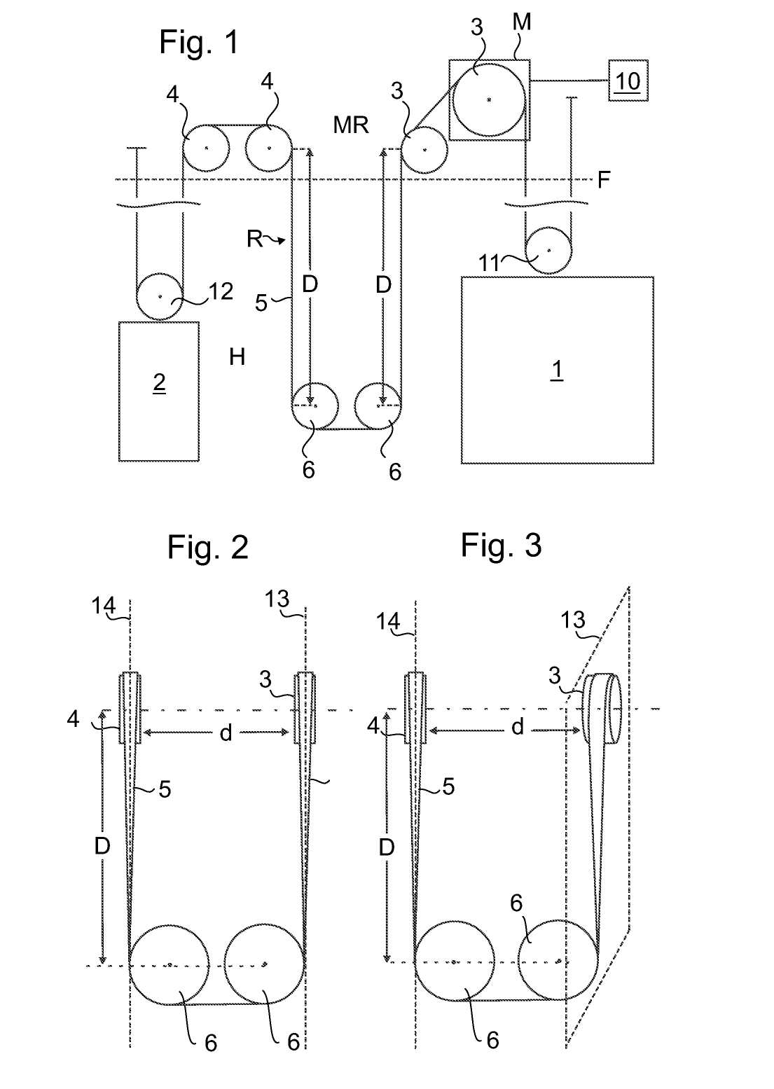

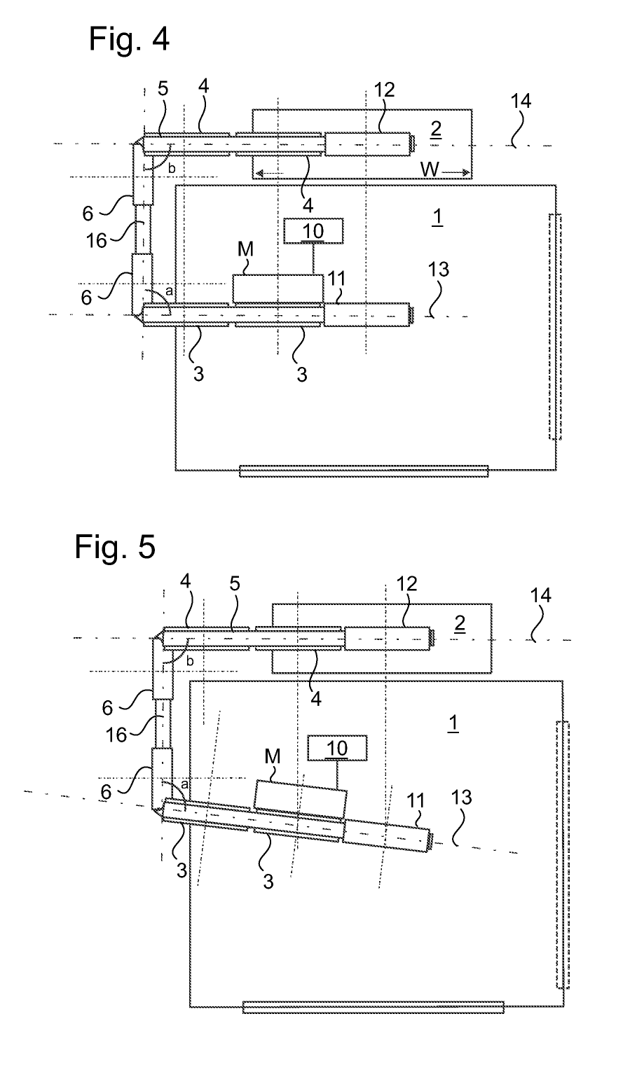

FIG. 1 illustrates an elevator according to a preferred embodiment. The elevator comprises a hoistway H, an elevator car 1 and a counterweight 2 vertically movable in the hoistway H, and a drive machine M, which provides moving force for the elevator car 1 under control of an elevator control system 10. The elevator comprises several stationary mounted rope wheels 3,4,6 for guiding the suspension roping R of the elevator. The suspension roping R is suspended to hang supported by these rope wheels 3,4,6. These rope wheels 3,4,6 include at least one first stationary mounted rope wheel 3, in this case two coplanar first stationary mounted rope wheels 3, positioned in proximity of the upper end of the hoistway H. These rope wheels 3,4,6 further include at least one second stationary mounted rope wheel 4, in this case two coplanar first stationary mounted rope wheels 4, positioned in proximity of the upper end of the hoistway H. FIG. 1 illustrates a flattened side view of the elevator. The three-dimensional aspects of the elevator are illustrated in FIGS. 2 and 3, as well as FIGS. 4 and 5 illustrating further preferable details for the embodiments of FIGS. 2 and 3, respectively.

The at least one first stationary mounted rope wheel 3 and the at least one second stationary mounted rope wheel 4 are horizontally spaced apart, at a distance d from each other, and rotate on different vertical planes of rotation 13,14. The elevator comprises a suspension roping R, comprising at least one belt-shaped rope 5 interconnecting the elevator car 1 and counterweight 2. Each rope 5 comprises a rope portion extending between the car 1 and counterweight 2 (i.e. a rope portion which passes from the car 1 to the counterweight 2) that passes around the at least one first stationary mounted rope wheel 3 (also referred to as the first rope wheel) and around the at least one second stationary mounted rope wheel 4 (also referred to as the second rope wheel). The rope 5 is not guided to pass directly from the first rope wheels 3 to the second rope wheels 4, because the first and second rope wheels 3,4 are positioned to rotate horizontally spaced apart and on different vertical planes of rotation 13,14. The passage from the first rope wheel 3 to the second rope wheel 4 is enabled by at least one intermediate stationary mounted rope wheel 6 (also referred to as third rope wheel). The at least one intermediate stationary mounted rope wheel 6 is positioned at a distance D apart from the first and second rope wheels 3, 4 to rotate on a plane of rotation 16 that intersects the planes of rotation 13,14 of the first and second wheels 3,4, and arranged to guide the portion of the rope 5 extending between the first and second rope wheels 3,4 to pass from the plane 13 of rotation of the at least one first wheel 3 along the plane of rotation of the intermediate stationary mounted rope wheels 6 to the plane of rotation 14 of the at least one second wheel 4. In this case, said rope portion extending between the car 1 and counterweight 2 passes around, preferably over as illustrated in Figures, the at least one first rope wheel 3, then around, preferably under as illustrated in Figures, the at least one intermediate rope wheel 6, and around, preferably over as illustrated in Figures, the at least one second rope wheel 4, these rope wheels 3, 4 and 6 being positioned in this order along the length of said rope portion. Thereby these rope wheels 3, 4 and 6 act on parts of the rope portion which are in this order consecutive. In the embodiment illustrated in Figures, the at least one intermediate rope wheel 6 includes two coplanar rope wheels 6, whereby the turning radius of the rope as well as the diameter of the at least one rope wheel 6 can be designed to be optimal independently of how great the distance d happens to be. The relative position of the two coplanar rope wheels 6 is preferably adjustable such that their distance in their radial direction can be adjusted. Thus, the rope can be adjusted to pass accurately tangentially to/from the at least one rope wheel 6. Each of the at least one intermediate wheel 6 is preferably a non-driven wheel, in other words a freely rotating wheel. It's main function is thereby to guide the at least one rope 5.

As can be seen in the FIGS. 1 to 5, in the preferred embodiments the rope portion extending between the first and second rope wheels 3,4 is arranged to pass from a rim of the at least one first rope wheel 3 to a rim of the at least one intermediate rope wheel 6, to pass along a rim of said at least one intermediate rope wheel 6 away from the plane of rotation 13 of the first rope wheel 3, and to pass along a rim of said at least one intermediate rope wheel 6 to the plane of rotation 14 of the at least one second rope wheel 4, and to pass from a rim of the at least one intermediate rope wheels 6 to a rim of the second wheel 4. The first second and third rope wheel 3,4,6 are so positioned that the rope portion departs tangentially from said rim of the first rope wheel 3, passes straight to the at least one third rope wheel 6, arrives tangentially to a rim thereof, departs tangentially a rim of the at least one third rope wheel 6, and arrives tangentially at a rim of the at least one second rope wheel 4.

The first stationary mounted rope wheel 3 are positioned to rotate on a first vertical plane of rotation 13, which is at a first (nonzero) angle a relative to the plane of rotation 16 of the at least one intermediate rope wheel 6, and the second stationary mounted rope wheels 4 rotate on a second vertical plane of rotation 14, which is at a second nonzero angle b relative to the plane of rotation 16 of the at least one intermediate rope wheel 6. Thus, the running direction of rope 5 is changed stepwise between the first and second rope wheels 3, 4. Thus, the passage of the rope 5 from the at least one first rope wheel 3 to the at least one second rope wheel 4 has been made easier.

The rope portion extending between the first and second rope wheels 3,4 is arranged to pass from a rim of the at least one first rope wheel 3 to a rim of the at least one intermediate rope wheel 6 twisting, while passing between these rims, around its longitudinal axis an amount of said first nonzero angle a, and to pass without twisting around its longitudinal axis along a rim of the at least one intermediate rope wheel 6 away from the plane of rotation 13 of the first rope wheel 3, and still without twisting around its longitudinal axis along a rim of the at least one intermediate rope wheel 6 to the plane of rotation 14 of the second rope wheel 4, and to pass from a rim of the intermediate rope wheel 6 to a rim of the at least one second rope wheel 4 twisting between the rim of the intermediate rope wheel 6 and the rim of the at least one second rope wheel 4 around its longitudinal axis an amount of said second nonzero angle b. With this arrangement the angle of twist per meter the rope 5 undergoes can be reduced. This is particularly advantageous for ropes having belt like shape and for any reason sensitive to or prone to resist a large angle of twist per meter.

Said distance D is preferably at least 4 meters, preferably between 4 to 10 meters, whereby the twist angle per meter is small enough to suit also for fragile ropes, such as ropes containing load bearing members, which are made of fiber reinforced composite material.

Said at least one intermediate rope wheels 6, in this case the two wheels 6, are positioned at a substantial vertical distance D lower than the first and second rope wheels (3, 4). Thus, the rope 5 can be routed in compact fashion. The at least one intermediate rope wheel 6, in this case the two wheels 6, are preferably positioned in the hoistway, whereby the distance D can be easily adjusted suitable without harming space efficiency of the elevator. In particular, each intermediate rope wheel 6 is preferably positioned beside the paths of the car 1 and counterweight 2, as illustrated for example in FIG. 4 or 5.

On one side of the stationary mounted first, second and third rope wheels 3,4,6, the roping (by its ropes) suspends the elevator car 1 and on the other side of the stationary mounted rope wheels, the roping (by its ropes) suspends the counterweight 2. In the preferred embodiments illustrated in Figures, the suspension roping R suspends the car 1 via at least one rope wheel 11 mounted on the car 1 and the counterweight 2 via at least one rope wheel 12 mounted on the counterweight 2. In this case, the rope 5 passes from the at least one first rope wheel 3 to the rope wheel 11 mounted on the car 1, which rope wheel 11 is coplanar with the at least one first rope wheel 3, passes under it, and passes further to a stationary fixing point. Correspondingly, the rope 5 passes from the at least one second rope wheel 4 to the rope wheel 12, mounted on the counterweight 12, which rope wheel 12 is coplanar with the at least one first rope wheel 3, passes under it, and passes further to a stationary fixing point. The rope wheel 11 is mounted at least substantially centrally on top of the car 1, on the car roof, and the rope wheel 12 is mounted at least substantially centrally on top of the counterweight 2. The use of the at least one intermediate rope wheel 6 provides freedom in routing of the ropes 5 in this way. Thus, the plane of rotation 14 can be, as illustrated, at least substantially aligned with the width direction w of the counterweight 2. Thus, the rope 5 can be turned within the vertical projection of the counterweight 2 even with solutions requiring a large turning radius, such as ropes containing load bearing members of fiber reinforced composite.

The counterweight 2 is arranged to travel beside the car 1. In the preferred embodiments, the counterweight 2 is arranged to travel vertically on first of the four lateral sides of path of the car 1, and the at least one intermediate rope wheel 6 is positioned on a second of the four lateral sides of path of the car 1, said first and second lateral sides being neighboring lateral sides of the four lateral sides of path of the car 1. The suspension of the car 1 and counterweight thereby leave optional to position the doorway 17 to the interior of the car 1 on either of two neighboring lateral sides of the four lateral sides of path of the car 1. As illustrated in Figures, the elevator further comprises a doorway 17 to the interior of the car 1. The doorway 17 is positioned either on a lateral side of the car 1 which is opposite the lateral side on which the counterweight travels or on a lateral side of the car 1 which is opposite the lateral side on which the at least one intermediate rope wheel 6 is positioned.

In the preferred embodiment as illustrated, the at least one second rope wheel 3 comprise a rope wheel 3, which is driven by a motor M under control of an automatic elevator control system 10. The driven rope wheel 3 engages the ropes 5 of the elevator roping R passing around the driven rope wheel 3. Thus, driving force can be transmitted from the motor M to the car 1 and counterweight 2 via the driven rope wheel 3 and the roping R so as to move the car 1 and counterweight 2. The elevator can have a machine room MR, but can alternatively be machine-roomless. FIG. 1 shows an elevator having a machine room MR, wherein the components positioned in machine room MR are illustrated above the horizontal line F. These components preferably include at least the motor M and the first and second rope wheels 3,4. Alternatively, the at least one second rope 4 wheel could comprise a rope wheel 4 driven by a motor under control of an automatic elevator control system. This is preferable particularly if the elevator is a machine roomless elevator, as in this way the motor M can be positioned away from the path of the elevator car 1.

The at least one first rope wheel 3 and the second rope wheel 4 are positioned at the same side of the plane of rotation 16 of the intermediate rope wheel 6, one of them turning the rope(s) 5 (from one side of the plane 16) on a rim thereof to the plane of rotation 16 of the at least one intermediate rope wheel 6 during movement of rope in a certain direction and the other of them turning the rope 5 back away from the plane of rotation 16 of the at least one intermediate rope wheel 6 (back towards said one side of the plane 16) during movement of rope 5 in said certain direction, and vice versa during movement of rope in a direction opposite said certain direction. The running direction of the rope, when viewed from above turns at least 120 degrees, but preferably at most 180 degrees between the first and second wheel 3,4. The first nonzero angle a and the second nonzero angle are both at most 90 degrees, whereby the rope 5 need not turn excessively. However, so as to achieve an efficient turn in the running direction of the rope 5, both are preferably at least 30 degrees, preferably more. In the embodiment of FIG. 4, the first and the second nonzero angle a,b are both 90 degrees. In the embodiment of FIG. 5, the first nonzero angle a is 75 degrees and the second nonzero angle b is 90 degrees. The running direction of rope 5 is changed stepwise between the first and second rope wheels 3, 4 such that, when viewed from above, the vertical projection has substantially the shape of a letter U. Thus, the car 1 and counterweight 2 can be suspended side by side centrally.

The planes of rotation 13 of the at least one first wheel 3 and the plane of rotation 14 of the at least one second wheel 4 can be parallel as illustrated in FIG. 4. Alternatively, as illustrated in FIG. 5, the planes 13,14 may be at an angle relative to each other, the angle being at most 60 degrees. The planes are in these both cases spaced apart in the axial direction of the first and second rope wheels 3,4.

The number of rope wheels belonging to each set of rope wheels 3, 4 and 6 is in the Figures illustrated to be two. Therefore, when referring to Figures plural form is used in description of these embodiments. However, the number of each set of rope wheels 3, 4 and 6 can alternatively differ from two, in which case in any of these sets of rope wheels there may be only one rope wheel instead of the two as illustrated, or more than the two rope wheels in coplanar configuration. Particularly, instead of having more than one coplanar rope wheels (3, 4, 6) any of the sets of rope wheels (3, 4, 6) can alternatively be substituted with only one rope wheel.

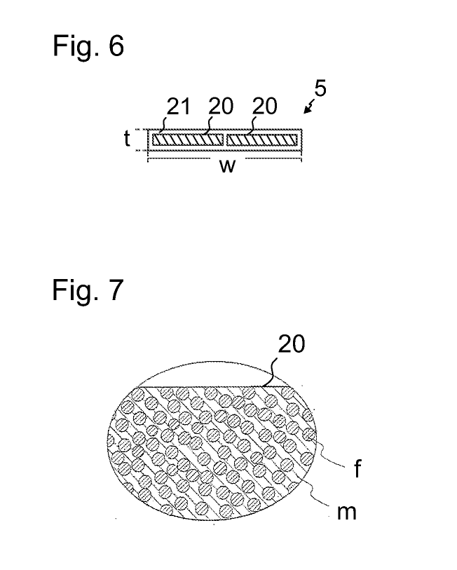

FIG. 6 illustrates the cross section of a preferred structure for an individual rope 5. The rope 5 is in the form of a belt, and thereby has a width w substantially larger than the thickness t thereof. This makes it well suitable for use in the elevator of the preferred embodiments, as bending of the rope 5 is in this way facilitated.

The rope 5 comprises continuous load bearing members 20, in this case two of them, extending in longitudinal direction of the rope 5 throughout the length of the rope 5. The load bearing members 20 are embedded in an elastic coating 21 forming the surface of the rope 5. The coating is preferably made of elastomer, such as polyurethane. The elastic coating 21 provides the rope 5 good wear resistance, protection, and isolates the load bearing members 20 from each other. The elastic coating 21 also provides the rope high friction, for instance for frictional traction contact with a driven rope wheels 3.

The number of the load bearing members 20 comprised in the rope 5 can alternatively be also greater or smaller than what is shown in FIG. 9. The load bearing member(s) 20 is/are parallel with the longitudinal direction of the rope 5, whereby they provide excellent longitudinal stiffness for the rope 5. So as to give a turning radius well suitable for elevator use, it is preferable that the width/thickness ratio of the rope is substantial, in particular more than 2, preferably more than 4 as illustrated. Thus, reasonable bending radius can be achieved for the rope when it contains substantially material of high bending rigidity, such as fiber reinforced composite material.

Preferably, each of said load bearing members 21 is made of composite material comprising reinforcing fibers f embedded in polymer matrix m. FIG. 7 illustrates inside the circle a partial and enlarged cross-section of the load bearing member 20 of the rope 5. Thus, the rope 5 has good longitudinal stiffness and low weight, which are among preferred properties for an elevator. The composite material, however, is relatively fragile and cannot withstand strong twist. The reinforcing fibers are most preferably carbon fibers, which are most advantageous in terms of longitudinal stiffness as well as weight. In combination of composite material of the load bearing member 21, especially when the fibers are carbon fibers, the amount of twist is important to be minimized. Thereby, the function provided by the intermediate rope wheel(s) 6 is specifically important in this context. To reduce buckling of fibers and to facilitate a small bending radius of the rope, among other things, it is preferred that the polymer matrix is hard, and in particular non-elastomeric. The most preferred materials are epoxy resin, polyester, phenolic plastic or vinyl ester. The matrix of the load bearing member 21 is preferably such that the module of elasticity E of the polymer matrix is over 2 GPa, most preferably over 2.5 GPa, yet more preferably in the range 2.5-10 GPa, most preferably of all in the range 2.5-3.5 GPa. One advantage among others, is a longer service life.

The composite material is preferably such that the individual reinforcing fibers are parallel with the length direction of the rope. Thus, they provide excellent longitudinal stiffness for the rope. The individual reinforcing fibers are preferably distributed in the matrix substantially evenly, such that substantially all the individual reinforcing fibers of the load bearing member are bound to each other by the matrix. The rope 5 is preferably in accordance with any one or the composite ropes disclosed in international patent application WO2009090299A1.

For the sake of clarity, the Figures illustrate only one rope 5. However, the number of said at least one belt-shaped rope 5 can be one as shown in the Figures, but preferably it is more than one. In this case, the several ropes pass side by side in at least substantially coplanar configuration. Thus, the complete mat of ropes formed by the several ropes together can have the corresponding route, shape and attitude as the single belt has in Figures.

It is to be understood that the above description and the accompanying Figures are only intended to illustrate the present invention. It will be apparent to a person skilled in the art that the inventive concept can be implemented in various ways. The invention and its embodiments are not limited to the examples described above but may vary within the scope of the claims.

1. An elevator comprising:
a hoistway;
an elevator car vertically movable in the hoistway;
a counterweight vertically movable in the hoistway;
at least one first stationary mounted rope wheel positioned in proximity of the upper end of the hoistway, and at least one second stationary mounted rope wheel positioned in proximity of the upper end of the hoistway, the at least one first stationary mounted rope wheel and the at least one second stationary mounted rope wheel being horizontally spaced apart and rotating on different vertical planes of rotation;
a roping, comprising at least one belt-shaped rope interconnecting the elevator car and counterweight and comprising a rope portion extending between the car and counterweight which passes around the at least one first stationary mounted rope wheel and around the at least one second stationary mounted rope wheel; and
at least one intermediate stationary mounted rope wheel, positioned at a distance apart from the at least one first rope wheel and the at least one second rope wheel to rotate on a plane of rotation that intersects the plane of rotation of the at least one first rope wheel and the plane of rotation of the at least one second rope wheel, and arranged to guide the portion of the rope extending between the at least one first rope wheel and the at least one second rope wheel to pass from the plane of rotation of the at least one first wheel to the plane of rotation of the at least one second wheel along the plane of rotation of the at least one intermediate stationary mounted rope wheel.

2. The elevator according to claim 1, wherein the rope portion extending between the at least one first and the at least one second rope wheel is arranged to pass from a rim of the first rope wheel departing tangentially therefrom, to a rim of the at least one intermediate rope wheel arriving tangentially thereto, to pass along a rim of said at least one intermediate rope wheel away from the plane of rotation of the first rope wheel, and to pass along a rim of said at least one intermediate rope wheel to the plane of rotation of the second rope wheel, and to pass from a rim of the at least one intermediate rope wheel departing tangentially therefrom, to the rim of the second wheel arriving tangentially thereto.

3. The elevator according to claim 1, wherein the at least one first stationary mounted rope wheel rotates on a first vertical plane of rotation, which is at a first nonzero angle relative to the plane of rotation of the at least one intermediate rope wheel, and the at least one second stationary mounted rope wheel rotates on a second vertical plane of rotation, which is at a second nonzero angle relative to the plane of rotation of the at least one intermediate rope wheel.

4. The elevator according to claim 3, wherein the rope portion extending between the first and second rope wheels is arranged to pass from a rim of the at least one first rope wheel to a rim of the at least one intermediate rope wheel twisting between the rim of the first rope wheel and the rim of the intermediate rope wheel around its longitudinal axis an amount of said first nonzero angle, to pass without twisting around its longitudinal axis along a rim of the at least one intermediate rope wheel away from the plane of rotation of the at least one first rope wheel, and without twisting around its longitudinal axis along a rim of the at least one intermediate rope wheel to the plane of rotation of the at least one second rope wheel, and to pass from the rim of the at least one intermediate rope wheel to the rim of the second rope wheel twisting between the rim of the intermediate rope wheel and the rim of the second rope wheel around its longitudinal axis an amount of said second nonzero angle.

5. The elevator according to any claim 1, wherein said at least one intermediate rope wheel is positioned at a substantial vertical distance lower than the first and second rope wheels.

6. The elevator according to claim 1, wherein said at least one intermediate rope wheel is positioned beside the paths of the car and counterweight.

7. The elevator according to claim 1, wherein on one side of the stationary mounted first, second and intermediate rope wheels, the roping suspends the elevator car and on the other side the roping suspends the counterweight.

8. The elevator according to claim 1, wherein each of the at least one intermediate wheel is a non-driven wheel.

9. The elevator according to claim 1, wherein said distance is at least 4 meters.

10. The elevator according to claim 1, wherein the roping suspends the elevator car via at least one rope wheel mounted on the car, and the counterweight via at least one rope wheel mounted on the counterweight.

11. The elevator according to claim 1, wherein the roping suspends the car via at least one rope wheel mounted at least substantially centrally on top of the car.

12. The elevator according to claim 1, wherein the roping suspends the counterweight via at least one rope wheel mounted at least substantially centrally on top of the counterweight.

13. The elevator according to claim 10, wherein the rope wheel mounted on the counterweight rotates on the plane of rotation of the at least one second rope wheel, which plane of rotation is at least substantially aligned with the width direction of the counterweight.

14. The elevator according to claim 1, wherein the running direction of each of said the at least one rope, when viewed from above turns at least 120 degrees between the first and second rope wheels.

15. The elevator according to claim 1, wherein each of said at least one rope comprises one or more continuous load bearing members extending in longitudinal direction of the rope throughout the length of the rope, which load bearing member(s) is/are made of composite material comprising reinforcing fibers embedded in a polymer matrix.

16. The elevator according to claim 1, wherein said distance is between 4 to 10 meters.

17. The elevator according to claim 1, wherein the running direction of each of said the at least one rope, when viewed from above turns at least 120 degrees, but at most 180 degrees between the first and second rope wheels.

18. The elevator according to claim 2, wherein the at least one first stationary mounted rope wheel rotates on a first vertical plane of rotation, which is at a first nonzero angle relative to the plane of rotation of the at least one intermediate rope wheel, and the at least one second stationary mounted rope wheel rotates on a second vertical plane of rotation, which is at a second nonzero angle relative to the plane of rotation of the at least one intermediate rope wheel.

19. The elevator according to claim 2, wherein said at least one intermediate rope wheel is positioned at a substantial vertical distance lower than the first and second rope wheels.

20. The elevator according to claim 3, wherein said at least one intermediate rope wheel is positioned at a substantial vertical distance lower than the first and second rope wheels.
